(19) United States
(12) Patent Application Publication
(10) Pub. No.: US 2007/0144559 A1
(43) Pub. Date: Jun. 28, 2007

(54) UNIT FOR PREVENTING A SUBSTRATE FROM DRYING, SUBSTRATE CLEANING APPARATUS HAVING THE UNIT AND METHOD OF CLEANING THE SUBSTRATE USING THE UNIT

(76) Inventors: Kwang-Shin Lim, Yongin-si (KR); Sung-Jae Han, Seongnam-si (KR); Yong-Hoon Lee, Suwon-si (KR); Hyung-Seok Choi, Yongin-si (KR); Ju-Ah Ryu, Seoul (KR); Yong-Joo Choi, Suwon-si (KR)

Correspondence Address: F. CHAU & ASSOCIATES, LLC, 130 WOODBURY ROAD, WOODBURY, NY, 11797, US

(21) Appl. No.: 11/611,524

(22) Filed: Dec. 15, 2006

(30) Foreign Application Priority Data
Dec. 22, 2005 (KR) 2005-127689

(51) Int. Cl. B08B 3/00; B08B 3/04

(52) U.S. Cl. 134/26; 134/198; 134/104.2; 134/61; 134/94.1; 134/34

(57) ABSTRACT

A unit for preventing a substrate from drying includes a transfer arm for transferring a substrate from a first bath containing a first cleaning solution to a second bath containing a second cleaning solution, a spraying part connected to the transfer arm, wherein the spraying part sprays a drying prevention solution from an upper portion of the substrate to a lower portion of the substrate, and a drainage container connected to the transfer arm, wherein the drainage container receives the drying prevention solution.

### CROSS-REFERENCE TO RELATED APPLICATION

This application claims priority under 35 USC § 119 to Korean Patent Application No. 2005-127689 filed on Dec. 22, 2005, the contents of which are herein incorporated by reference in their entirety.

### BACKGROUND OF THE INVENTION

1. Technical Field

Example embodiments of the present invention relate to a unit for preventing a substrate from drying, a substrate cleaning apparatus having the unit, and a method of cleaning the substrate using the unit. More particularly, example embodiments of the present invention relate to a unit for preventing a substrate from drying while transferring the substrate in a cleaning process, a substrate cleaning apparatus including the unit, and a method of cleaning the substrate.

2. Description of the Related Art

A fabrication process for a semiconductor device may include a deposition process to form a thin layer on a substrate such as a semiconductor substrate and a mask substrate. The fabrication process may further include a chemical mechanical polishing (CMP) process to planarize the thin layer, a photolithography process to form a photoresist pattern on the thin layer, an etching process to partially etch the thin layer using the photoresist pattern, to thereby form an electrical pattern on the substrate, and a cleaning process to remove contaminants from the substrate.

The cleaning process cleans the substrate using, for example, a chemical solution contained in a plurality of baths. In the cleaning process, a transfer arm transfers the substrate from one bath to another bath.

When moving the substrate from one bath to another bath using the transfer arm, the substrate having the cleaning solution thereon can be exposed to the air. Once the substrate is exposed to the air, the cleaning solution on the substrate may be dried. When the cleaning solution on the substrate is dried, contaminants in the air may adhere to the substrate and may contaminate the substrate.

An apparatus for changing a direction of a substrate while the substrate is showered has been used to keep the substrate wet. However, a shower pipe spraying liquid onto the substrate is disposed in a treatment container so that the substrate remains wet only in the treatment container. Thus, the substrate may dry while transferring the substrate from one bath to another bath.

### SUMMARY OF THE INVENTION

Example embodiments of the present invention provide units for preventing a substrate from being dried while transferring the substrate in a cleaning process.

Example embodiments of the present invention provide a substrate cleaning apparatus including a unit for preventing the substrate from drying.

Example embodiments of the present invention provide a method of cleaning a substrate for preventing the substrate from being dried while transferring the substrate in a cleaning process of cleaning the substrate using a cleaning solution.

According to an example embodiment of the present invention, a unit for preventing a substrate from drying comprise a transfer arm for transferring a substrate from a first bath containing a first cleaning solution to a second bath containing a second cleaning solution, a spraying part connected to the transfer arm, wherein the spraying part sprays a drying prevention solution from an upper portion of the substrate to a lower portion of the substrate, and a drainage container connected to the transfer arm, wherein the drainage container receives the drying prevention solution.

In an example embodiment of the present invention, the unit for preventing a substrate from drying may further include a driving part changing a position of the drainage container to prevent the drainage container from interfering a movement of the substrate when the transfer arm loads the substrate into the baths or unloads the substrate from the baths.

In an example embodiment of the present invention, the transfer arm may hold the substrate to be positioned vertically with respect to a ground.

In an example embodiment of the present invention, a bottom surface of the drainage container may be inclined toward a hole to deplete the drying prevention solution.

In an example embodiment of the present invention, the drying prevention solution may include de-ionized water.

In an example embodiment of the present invention, the substrate may include a semiconductor substrate or a mask substrate.

According to an example embodiment of the present invention, a substrate cleaning apparatus comprises at least two baths each of which contains a cleaning solution for cleaning a substrate, and a drying prevention unit positioned between the at least two baths, wherein the drying prevention unit sprays a drying prevention solution.

In an example embodiment of the present invention, the drying prevention unit may include a transfer arm transferring the substrate. A spraying part positioned over the substrate may spray the drying prevention solution onto an upper portion of the substrate while transferring the substrate. A drainage container under the substrate may receive the drying prevention solution sprayed from the spraying pad.

In an example embodiment of the present invention, the substrate cleaning apparatus may further include a driving pad changing a position of the drainage container for preventing the drainage container from hindering the transfer arm to load/unload the substrate into/from the baths.

In an example embodiment of the present invention, the drying prevention solution may include de-ionized water.

According to an example embodiment of the present inventions method of cleaning a substrate comprises

dipping the substrate in a first bath including a first cleaning solution, transferring the substrate from the first bath to a second bath including a second cleaning solutions spraying a drying prevention solution to the substrate, and dipping the substrate in the second bath.

In an example embodiment of the present invention, the method may further include repeating a sequential transferring of the substrate from the second bath to an N-th bath and a sequential cleaning of the substrate in the N-th bath, wherein N is an integer more than 2.

In an example embodiment of the present invention, the method may further include drying the substrate in the second bath.

In an example embodiment of the present invention, the method may further include collecting the sprayed drying prevention solution.

In an example embodiment of the present invention, the drying prevention solution may include deionized water.

### BRIEF DESCRIPTION OF THE DRAWINGS

Example embodiments of the present invention can be understood in more detail from the following description taken in conjunction with the accompanying drawings, in which:

FIG. 1 is a perspective view illustrating a unit for preventing a substrate from drying in accordance with an example embodiment of the present invention;

FIG. 2 is a perspective view illustrating an interior of a driving part in FIG. 1 according to an example embodiment of the present invention;

FIG. 3 is a perspective view illustrating a movement of a drainage container in FIG. 1 according to an example embodiment of the present invention;

FIG. 4 is a cross-sectional view illustrating a substrate cleaning apparatus in accordance with an example embodiment of the present invention;

FIG. 5 is a cross-sectional view illustrating a substrate being loaded or unloaded into/from the bath in FIG. 4; and

FIG. 6 is a flow chart illustrating a method of cleaning a substrate in accordance with an example embodiment of the present invention.

### DESCRIPTION OF THE EMBODIMENTS

The invention is described more fully hereinafter with reference to the accompanying drawings, in which embodiments of the invention are shown. The present invention may, however, be embodied in many different forms and should not be construed as limited to the embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

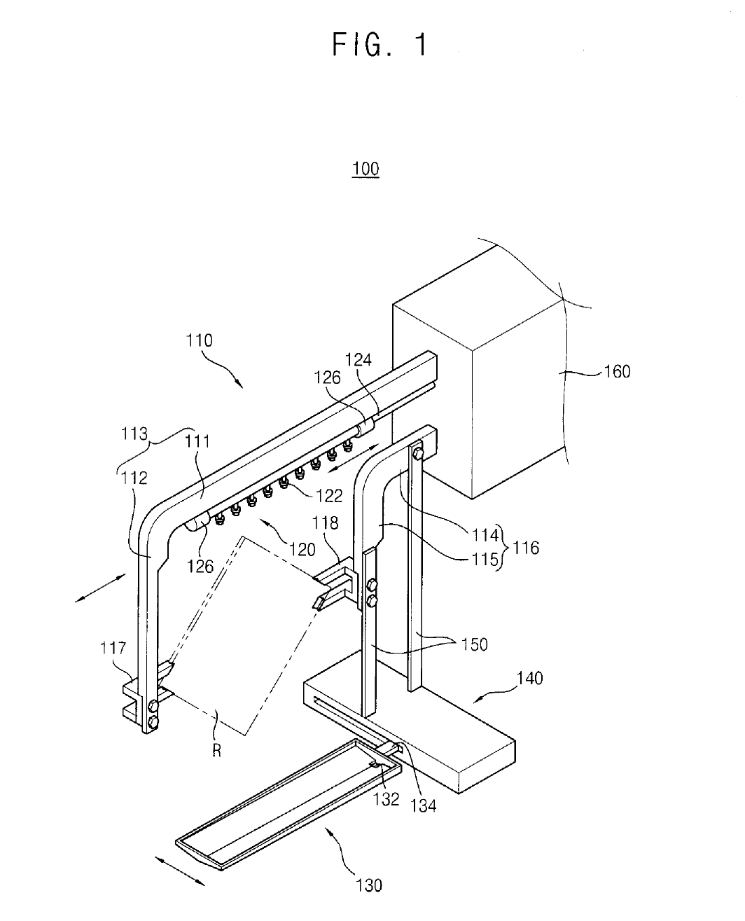

FIG. 1 is a perspective view illustrating a unit for preventing a substrate from drying in accordance with an example embodiment of the present invention.

Referring to FIG. 1, a unit 100 for preventing a substrate from drying includes a transfer arm 110, a spraying part 120, a drainage container 130, a driving part 140, a fixing part 150 and a body 160.

The transfer arm 110 transfers a semiconductor substrate used for manufacturing a semiconductor device, or a reticle substrate R used for projecting a circuit pattern on the semiconductor substrate. In some embodiments of the present invention, the transfer arm 110 transfers the reticle substrate R.

In a wet cleaning for the reticle substrate R, the reticle substrate R is sequentially immersed into a chemical treating bath, a quick dumped rinse (QDR) bath and a drying bath. The reticle substrate R is dipped into the chemical treating bath including a cleaning solution. Residual chemicals are removed from the reticle substrate R in the QDR bath. Then, the reticle substrate R is dried in the drying bath. A transfer of the reticle substrate R between the baths is performed by the transfer arm 110 according to an example embodiment of the present invention.

The transfer arm 110 can be connected to the body 160. The body 160 includes a driving part (not shown) for driving the transfer arm 110. The transfer arm 110 includes a first frame 113, a second frame 116, a first supporting member 117 and a second supporting member 118.

The first frame 113 includes a first horizontal frame 111 and a first vertical frame 112. The first horizontal frame 111 extends in parallel from a first position of a first side of the body 160. The first vertical frame 112 extends downwardly from an end of the first horizontal frame 111 in a vertical direction.

The second frame 116 includes a second horizontal frame 114 and a second vertical frame 115. The second horizontal frame 114 extends in parallel from a second position of the first side of the body 160. In an example embodiment of the present invention, the second position can be lower than the first position. In example some example embodiments of the present invention, the first and the second horizontal frames 111 and 114 are substantially parallel to each other. The second vertical frame 115 extends downwardly from an end of the second horizontal frame 114. The first and the second vertical frames 112 and 115 are arranged in parallel with each other.

According to an example embodiment of the present invention, the first and the second frames 113 and 116 may have an “L” shape, respectively, and may be positioned on the same plane. The first frame 113 may be substantially larger than the second frame 116. The first and the second frames 113 and 116 may move horizontally by operating the driving part such that a distance between the first and the second vertical frames 112 and 115 may be changed.

The first supporting member 117 may be positioned at a lower end of the first vertical frame 112. The second supporting member 118 may be disposed at a lower end of the second vertical frame 115. The first and the second supporting members 117 and 118 may hold or release the reticle substrate R in accordance with a movement of the first and the second frames 113 and 116. In an example embodiment of the present invention, when the first and the second vertical frames 112 and 115 move towards each other, the first and the second supporting members 117 and 118 hold the reticle substrate R between the first and the second frames 113 and 116. When the first and the second vertical frames 112 and 115 move away from each other, the first and the second supporting members 117 and 118 release the reticle substrate R from the first and the second frames 113 and 116.

The first and the second vertical frames 112 and 115 are used to hold the reticle substrate R such that the first and the second frames 112 and 115 may stand vertically with respect to a floor.

When the transfer arm 110 transfers the reticle substrate R from one bath to another bath, the reticle substrate R is exposed to the air. Thus, a cleaning solution, which may remain on the reticle substrate R, may be dried. As a result, a surface of the reticle substrate R may be exposed to the air. When the surface of the reticle substrate R is exposed to the air; contaminants in the air may be adhered to the reticle substrate R and may contaminate the reticle substrate R.

The spraying part 120 sprays a drying prevention solution toward the reticle substrate R to prohibit the reticle substrate from being dried while transferring the reticle substrate R. Thus, the reticle substrate R may be suppressed to be dried by the air, thereby preventing the reticle substrate R from being contaminated. The drying prevention solution may include, for example, de-ionized water.

The spraying part 120 includes a nozzle 122, a supplying line 124 and a fixing member 126. In an example embodiment of the present invention, the nozzle 122 may have a pipe shape. The nozzle 122 extends from a lower end of the first horizontal frame 111 in parallel with the first horizontal frame 111. The nozzle 122 sprays, for example, the de-ionized water downwardly. The nozzle 122 may have a length substantially larger than a width of the reticle substrate R. Thus, the nozzle 122 may spray the de-ionized water to cover an entire surface of the reticle substrate R, which is vertically held with respect to the floor by the first and the second supporting members 117 and 118. The fixing member 126 is connected to the nozzle 112. The fixing member 126 fixes the nozzle 122 to the first horizontal frame 111.

The drainage container 130 is positioned under the reticle substrate R. The drainage container 130 collects the de-ionized water, which is sprayed from the nozzle 122 and flows along the surface of the reticle substrate R. Thus, the drainage container 130 may prevent the de-ionized water from flowing into the baths and dropping between the baths. When the de-ionized water flows into the baths, a composition of the cleaning solution may change. When the de-ionized water drops between the baths, an apparatus for cleaning the reticle substrate R may be contaminated.

A drainage hole 132 to drain the de-ionized water is positioned at a lower surface of the drainage container 130. The drainage hole 132 is connected to a drain pipe (not shown). The lower surface of the drainage container 130 may be inclined toward the drainage hole 132. Thus, the de-ionized water collected in the drainage container 130 may be drained through the drainage hole 132. A connection member 134 may be positioned at an outer side of the drainage container 130.

The driving part 140 is connected to the drainage container 130 through the connection member 134. The driving part 140 moves the drainage container 130 horizontally. Therefore, the driving part 140 may not interfere with the reticle substrate R from moving at a predetermined direction for example, when the reticle substrate R is loaded into the baths or unloaded from the baths.

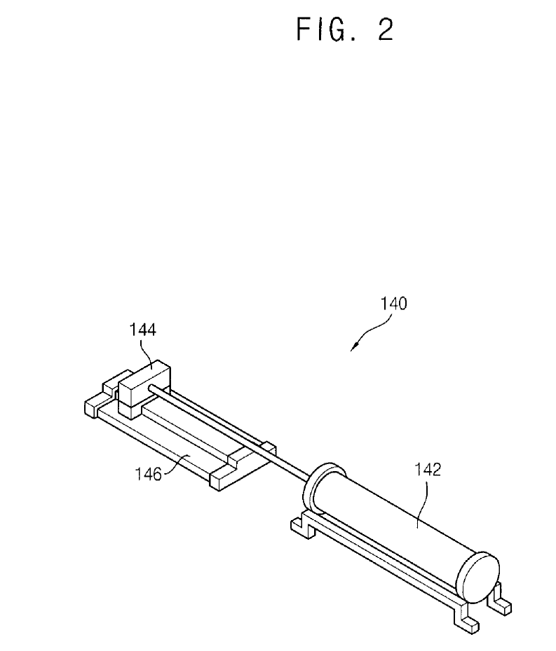

FIG. 2 is a perspective view illustrating an interior of the driving part in FIG. 1 according to an example embodiment of the present invention.

Referring to FIGS. 1 and 2, the driving part 140 includes a pneumatic cylinder 142 a transfer member 144 and a guider 146.

The pneumatic cylinder 142 provides a driving force for moving the drainage container 130. The pneumatic cylinder 142 has a piston to linearly move by, for example an air pressure.

The transfer member 144 is connected to the piston such that the transfer member 144 moves linearly in accordance with the movement of the piston. The transfer member 144 is connected to the connection member 134 to linearly move the drainage container 130. Thus, the driving part 140 moves the drainage container 130 vertically with respect to a plane defined by the first and the second frames 113 and 116.

The guider 146 is positioned under the transfer member 144 to guide a movement of the transfer member 144. For example, the guider 146 has a guide rail to prevent the transfer member 144 from being derailed from the guider 146. In an example embodiment of the present invention, the driving part 140 may horizontally transfer the drainage container 130. In an example embodiment of the present invention the driving part 140 may rotate and transfer the drainage container 130.

Referring to FIG. 1, the fixing part 150 has a first end of the fixing part 150 being connected to the transfer arm 110 and a second end of the fixing part 150 is connected to the driving part 140. The fixing part 150 connects the driving part 140 to the body 160. The drainage container 130 may be connected to the fixing part 150 through the driving part 140. The first and second ends of the fixing part 150 are connected to the second frame 116. In an example embodiment of the present invention, the first and second ends of the fixing part 150 may be connected to the first frame 113.

In an example embodiment of the present invention, the unit 100 for preventing the substrate from drying may further include another fixing part. When two or more fixing parts are connected between the transfer arm 110 and the driving part 140, the driving part 140 is secured to the body 160.

According to an example embodiment of the present invention, the unit 100 may prevent the reticle substrate R from being dried while transferring the reticle substrate R from one bath to another bath. According to an example embodiment of the present invention, the drainage container 130 may receive and collect the sprayed de-ionized water.

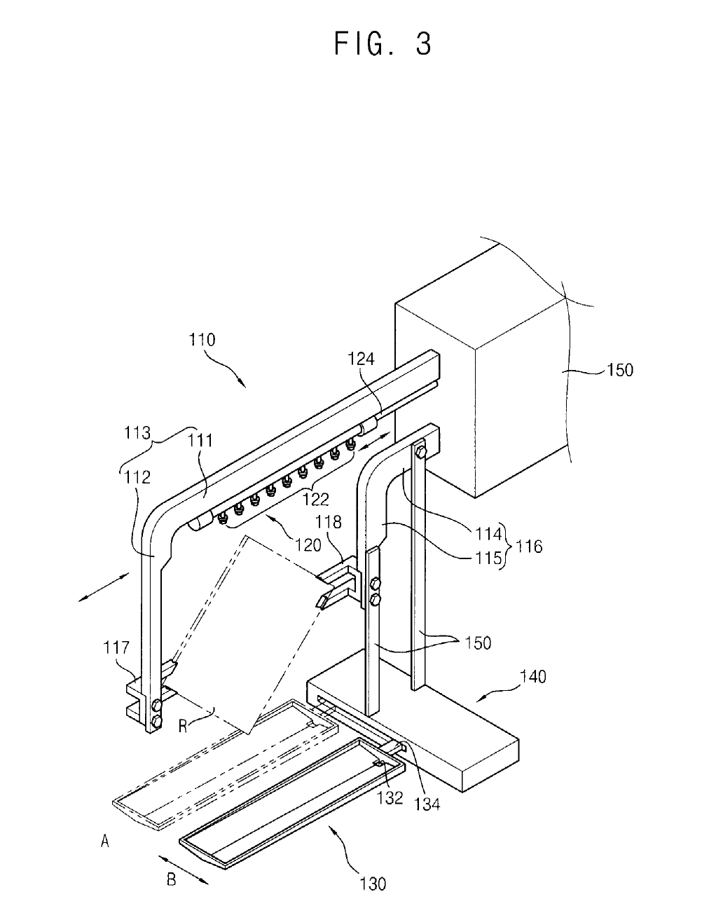

FIG. 3 is a perspective view illustrating a movement of the drainage container in FIG. 1 according to an example embodiment of the present invention.

Referring to FIG. 3, when the transfer arm 110 transfers the reticle substrate R, the drainage container 130 is located at a position A at which the drainage container 130 is positioned under the reticle substrate R. At the position A, the transfer arm 110 transfers the reticle substrate R, and the nozzle 122 sprays the de-ionized water. When the nozzle 122 sprays the de-ionized water, the drainage container 130 located at the position A collects the de-ionized water that is sprayed from the nozzle 122 and flows along the surface of the reticle substrate R.

That is, when the drainage container 130 is located at the position A, the nozzle 122 sprays the de-ionized water. After the de-ionized water flows along the surface of the reticle substrate R, the de-ionized water drops into the drainage container 130 and is drained through the drainage hole 132.

When the transfer arm 110 loads/unloads the reticle substrate R into/from each of the baths, the drainage container 130 is located at a position B apart from the reticle substrate R. That is, when the drainage container 130 is positioned at the position B, the transfer arm 110 stops the reticle substrate R from being transferred from one bath to another, and loads/unloads the reticle substrate R into/from each of the baths. Then, the nozzle 122 stops spraying the de-ionized water.

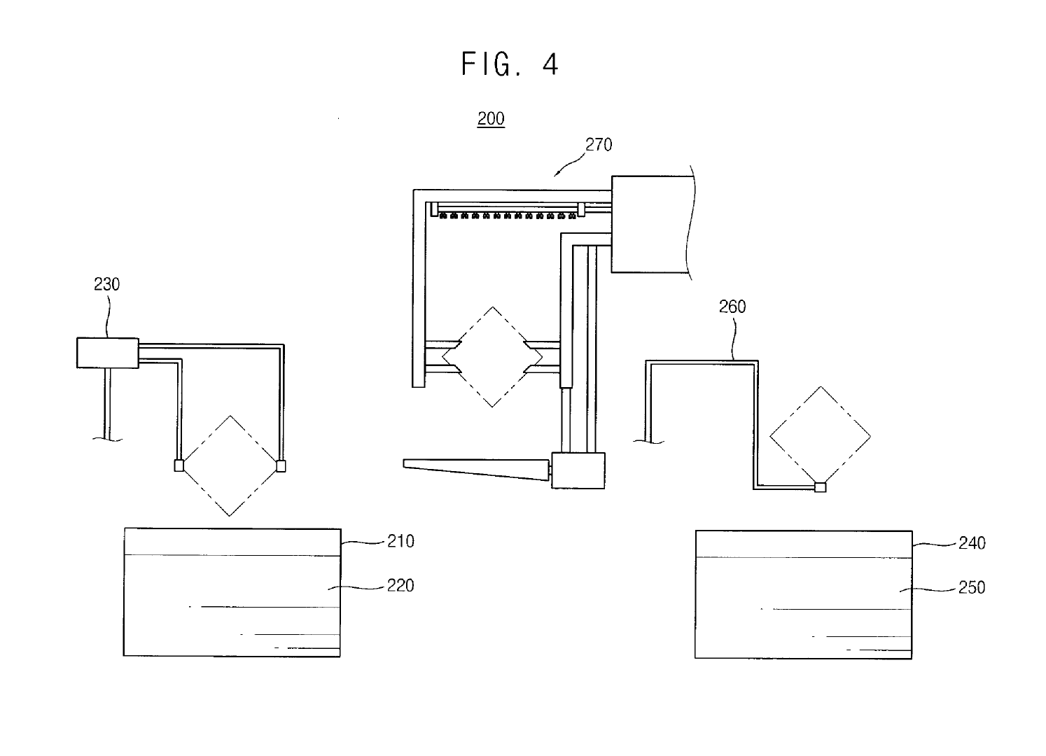

FIG. 4 is a cross-sectional view illustrating a substrate cleaning apparatus in accordance with an example embodiment of the present invention. Referring to FIG. 4, a substrate cleaning apparatus 200 includes a first bath 210, a first vibration arm 230, a second bath 240, a second vibration arm 260 and a unit 270 for preventing a substrate from drying.

The first bath 210 contains a first cleaning solution 220. The first cleaning solution 220 may chemically clean a substrate such as a semiconductor substrate used for manufacturing a semiconductor device, or a reticle substrate R used for projecting a circuit pattern onto the semiconductor substrate. In an example embodiment of the present invention, the first cleaning solution 220 may be used to clean the reticle substrate R.

Contaminants on the reticle substrate R are removed using the first cleaning solution 220, The contaminants may be generated in a photolithography process or an etching process for forming the reticle substrate R, or in a process of forming a pellicle for protecting a reticle. The first cleaning solution may include, for example, a standard cleaning solution (SC-1) comprising ammonium hydroxide, hydrogen peroxide and de-ionized water.

The first vibration arm 230 holds two sides of the reticle substrate R. The first vibration arm 230 may be used in a cleaning bath, which provides a microwave vibration to the reticle substrate R in a cleaning process of the reticle substrate R. The first vibration arm 230 transfers the reticle substrate R to the first bath 210 and then dips the reticle substrate R into the first bath 210 including the first cleaning solution 220. The first vibration arm 230 holds the reticle substrate R while the reticle substrate R is cleaned in the first bath 210 containing the first leaning solution 220. When the reticle substrate R is dipped into the first bath 210 containing the first cleaning solution 220, the first vibration arm 230 vibrates the reticle substrate R to remove the contaminants on the reticle substrate R. The first vibration arm 230 removes the reticle substrate P from the first bath 210 containing the first cleaning solution 220.

The second bath 240 contains a second cleaning solution 250. The first cleaning solution 220 remaining on the reticle substrate R is removed using the second cleaning solution 250 that may include de-ionized water.

The second vibration arm 260 holds a lower side of the reticle substrate R. In an example embodiment of the present invention, the second vibration arm 260 may be used in a cleaning bath, which does not provide a microwave vibration to the reticle substrate R in a cleaning process for cleaning the reticle substrate R. The second vibration arm 260 has characteristics similar to those of the first vibration arm 230.

According to an example embodiment of the present invention, a first chemical bath for removing contaminants from the substrate using a first cleaning solution, a first and second cleaning baths for removing the first chemical solution remaining on the substrate, a second chemical bath for removing contaminants from the substrate using a second cleaning solution and a third and fourth cleaning baths for removing the second cleaning solution remaining on the substrate may be provided.

The unit 270 is positioned between the first bath 210 and the second bath 240. The unit 270 transfers the reticle substrate R from the first bath 210 to the second bath 240 after cleaning the reticle substrate R in the first bath 210. The unit 270 sprays a drying preventing solution to prevent the reticle substrate R from being dried while transferring the reticle substrate P, and the unit 270 collects the sprayed drying preventing solution.

The unit 270 may be substantially similar to the unit 100 as described with reference to FIGS. 1 to 3.

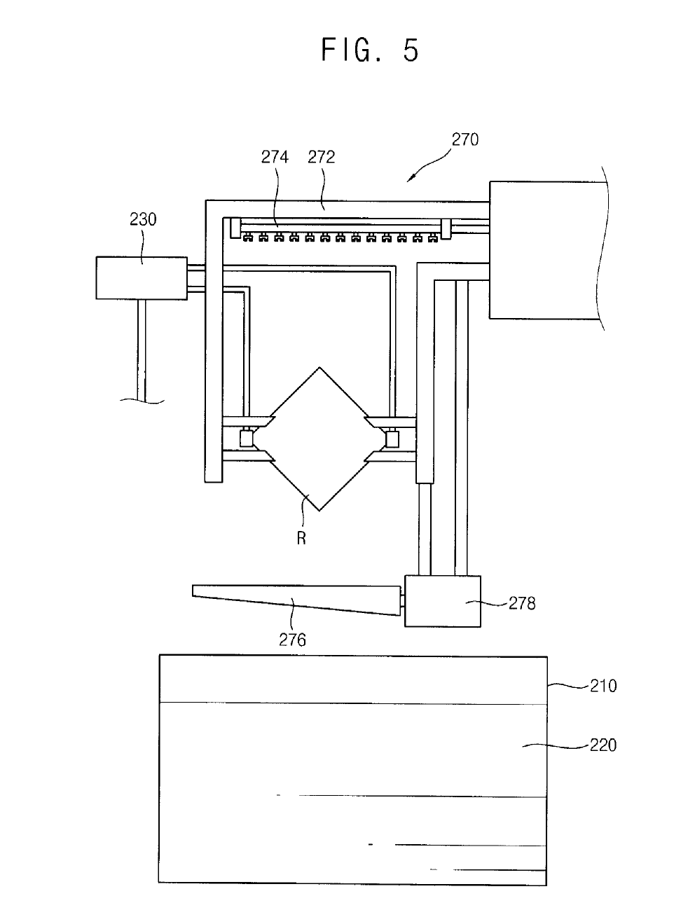

FIG. 5 is a cross-sectional view illustrating a method of loading the substrate R into the first bath 210 and unloading the substrate R from the first bath 210.

Referring to FIG. 5, when a transfer arm 272 of the unit 270 transfers the reticle substrate R, a drainage container 276 moves along a traffic line of the reticle substrate R such that the drainage container 276 is positioned under the reticle substrate R, and a spraying part 274 sprays the de-ionized water toward the reticle substrate R. Thus, the reticle substrate R may be prevented from being dried while being transferred from one bath to another bath.

After the de-ionized water flows along a surface of the reticle substrate R, the de-ionized water drops into the drainage container 276 and drains through the drainpipe (not shown).

After the transfer arm 272 transfers the reticle substrate R to the first bath 210 containing the first cleaning solution 220, the spraying part 274 stops spraying the de-ionized water toward the reticle substrate R. The drainage container 276 moves horizontally by operating the driving part 278 to be positioned apart from an upper portion of the reticle substrate R, such that the transfer arm 272 may transfer the reticle substrate R without being interrupted by the drainage container 276.

Then, the first vibration arm 230, which is located near the first bath 210, ascends to hold, for example, two sides of the reticle substrate R. When the first vibration arm 230 holds the reticle substrate R, the transfer arms 272 releases the reticle substrate R. Thus, the reticle substrate R is loaded into the first bath 210.

The first vibration arm 230 descends to dip the reticle substrate R into the first bath 210 containing the first cleaning solution 220. While the first vibration arm 230 vibrates the reticle substrate R, the first cleaning solution 220 may clean the reticle substrate R.

After completing the cleaning process in the first bath 210, the first vibration arm 230 ascends, and the transfer arm 272 holds, for example, two sides of the reticle substrate R. When the transfer arm 272 holds the reticle substrate R, the first vibration arm 230 releases the reticle substrate R from the transfer arm 272 and completes an unloading process of the reticles substrate R from the first bath 210.

The drainage container 276 moves horizontally to be positioned under the reticle substrate R by operating the driving part 278. When the spraying part 274 sprays the de-ionized water, the transfer arm 272 transfers the reticle substrate R to the second bath 240 containing the second cleaning solution 250.

Then, the reticle substrate R is cleaned using the second vibration arm 260 in the cleaning process, which may be performed in the second bath 240.

According to an example embodiment of the present invention, the substrate cleaning apparatus 200 may prevent the reticle substrate R from being dried when transferring the reticle substrate R, thereby preventing the reticle substrate R from being contaminated by contaminants in the air.

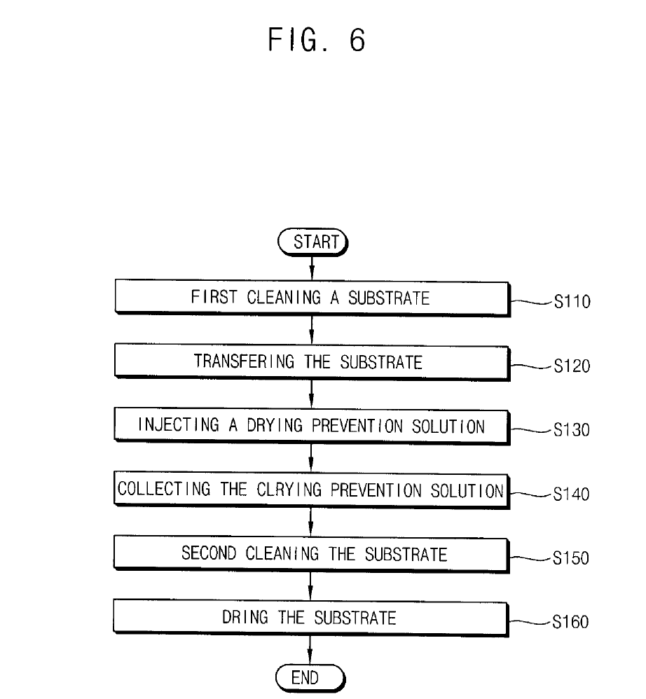

FIG. 6 is a flow chart illustrating a method of cleaning a substrate in accordance with an example embodiment of the present invention.

Referring to FIG. 6, a method of cleaning a substrate may be applied to clean a semiconductor substrate used for manufacturing a semiconductor device or a reticle substrate R used for projecting a circuit pattern on the semiconductor substrate. In an example embodiment of the present invention, the transfer arm transfers the reticle substrate R.

The reticle substrate R with contaminants on a surface is transferred to a first bath having a first cleaning solution. The contaminants may be generated in a photolithographic process or an etching process to form the reticle substrate R or in a process of forming a pellicle for protecting a reticle. The reticle substrate R is dipped into the first bath and is vibrated. The contaminants chemically reacted with the first cleaning solution are removed from the reticle substrate. Thus, the reticle substrate is cleaned by a chemical cleaning process (step S110).

Then, the reticle substrate is transferred to a second bath including a second cleaning solution, so that the first cleaning solution remaining on a surface of the reticle substrate is removed from the reticle substrate (step S120).

When the reticle substrate is exposed to the air, the reticle substrate may be dried. Contaminants in the air may stick to the air dried reticle substrate to contaminate the reticle substrate. Thus, when the reticle substrate is transferred, a dying preventing solution is sprayed toward the reticle substrate to prevent the reticle substrate from being dried (step S130).

The drying prevention solution may be sprayed from an upper portion of the reticle substrate to a lower portion of the reticle substrate. The reticle substrate may be transferred vertically with respect to the floor for receiving the drying prevention solution throughout an entire surface of the reticle substrate. The drying prevention solution may include, for example, de-ionized water.

The sprayed drying prevention solution flows over an entire surface of the reticle substrate and drops from the reticle substrate. The drying prevention solution that drops into the first bath or another bath may cause a change of composition of the cleaning solution, which is contained by the first bath or another bath. The drying prevention solution that drops into a portion disposed between the baths may cause a contamination of an apparatus for a cleaning process. Thus, the sprayed dying prevention solution is collected (step S140).

The reticle substrate, which is wet by the sprayed drying prevention solution, is transferred from the first bath to the second bath. The reticle substrate is then dipped into the second bath containing the second cleaning solution while the reticle substrate is vibrated. The second cleaning solution removes the first cleaning solution remaining on the surface of the reticle substrate. Thus, the reticle substrate may be cleaned by, for example, a quick dumped rinse (QDR) cleaning process (step S150).

The reticle substrate may be cleaned by the chemical cleaning process and the QDR process. In an example embodiment of the present invention, a first chemical cleaning process a first and second QDR processes to remove the first chemical solution from the reticle substrate, a second chemical cleaning process, a third and a fourth QDR process to remove the second chemical solution from the reticle substrate may be sequentially performed.

The reticle substrate is transferred to a dryer to be dried (step S160). The reticle substrate may be dried using for example, isopropyl alcohol vapor.

According to an example embodiment of the present invention, the reticle substrate may be prevented from being dried even though the reticle substrate is exposed to the air when transferred. Thus, the reticle substrate may be suppressed from being contaminated by contaminants in the air.

According to an example embodiment of the present invention, when a substrate is transferred from one bath to another bath, the de-ionized water is sprayed to prevent the substrate from being dried. This may suppress the substrate from being contaminated, which may occur when the substrate is exposed to the air. According to an example embodiment of the present invention, a drainage container may collect the de-ionized water.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed and that modifications to the disclosed embodiments, as well as other embodiments, are intended to be included within the scope of the appended claims. The present invention is defined by the following claims, with equivalents of the claims to be included therein.

What is claimed is:

1. A unit for preventing a substrate from drying, the unit comprising:
a transfer arm for transferring a substrate from a first bath containing a first cleaning solution to a second bath containing a second cleaning solution;
a spraying part connected to the transfer arm, wherein the spraying part sprays a drying prevention solution from an upper portion of the substrate to a lower portion of the substrate; and
a drainage container connected to the transfer arm, wherein the drainage container receives the drying prevention solution.

2. The unit of claim 1 further comprising a driving part changing a position of the drainage container.

3. The unit of claim 1, wherein the transfer arm holds the substrate to be vertically positioned with respect to a floor.

4. The unit of claim 1 wherein a bottom surface of the drainage container is inclined toward a hole through which the drying prevention solution is drained.

5. The unit of claim 1 wherein the drying prevention solution includes de-ionized water.

6. The unit of claim 1, wherein the substrate includes a semiconductor substrate or a mask substrate.

7. A substrate cleaning apparatus comprising:
at least two baths each of which contains a cleaning solution for cleaning a substrate; and
a drying prevention unit positioned between the at least two baths, wherein the drying prevention unit sprays a drying prevention solution onto a surface of the substrate when the substrate is transferred from one bath to another.

8. The substrate cleaning apparatus of claim 7, wherein the drying prevention unit comprises:
a transfer arm transferring the substrate;
a spraying part for spraying the drying prevention solution toward an upper portion of the substrate while transferring the substrate; and
a drainage container for receiving the drying prevention solution sprayed from the spraying part.

9. The substrate cleaning apparatus of claim 7, further comprising a driving unit for changing a position of the drainage container.

10. The substrate cleaning apparatus of claim 7, wherein the drying prevention solution includes de-ionized water.

11. A method of cleaning a substrate, the method comprising:
dipping the substrate in a first bath including a first cleaning solution;
transferring the substrate from the first bath to a second bath including a second cleaning solution;
spraying a drying prevention solution onto the substrate; and
dipping the substrate in the second bath.

12. The method of claim 11, further comprising transferring the substrate from the second bath to an Nth bath and dipping the substrate in the Nth bath, wherein N is an integer more than 2.

13. The method of claim 11, further comprising drying the substrate cleaned in the second bath.

14. The method of claim 11 further comprising collecting the sprayed drying prevention solution.

15. The method of claim 11, wherein the drying prevention solution includes de-ionized water.
